(19) United States
(12) Patent Application Publication
(10) Pub. No.: US 2026/0288361 A1
(43) Pub. Date: Sep. 24, 2026

(54) PROGRAMMING VERIFICATION IN A MEMORY SYSTEM

(71) Applicant: Micron Technology, Inc., Boise, ID (US)

(72) Inventors: Yu-Chung Lien, San Jose, CA (US); Zhenming Zhou, San Jose, CA (US)

(21) Appl. No.: 19/083,291

(22) Filed: Mar. 18, 2025

(51) Int. Cl. G06F 3/06

(52) U.S. Cl. CPC G06F 3/0655; G06F 3/0604; G06F 3/0673

(57) ABSTRACT

Methods, systems, and devices for programming verification in a memory system are described. A memory system may increase, during a programming operation for a word line, the voltage applied to the word line from a first level to a second level higher than the first level, where a set of memory cells coupled with the word line is attempted to be written with a set of multi-bit values based on increasing the voltage to the second level. The memory system may decrease, during a verification operation for the programming operation, the voltage applied to the word line to a third level lower than the first level. The memory system may determine whether the set of memory cells has been written with the set of multi-bit values based on decreasing the voltage applied to the word line.

### TECHNICAL FIELD

The following relates to one or more systems for memory, including programming verification in a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports programming verification in a memory system in accordance with examples as disclosed herein.

FIG. 2 shows example threshold voltage distributions that support programming verification in a memory system in accordance with examples as disclosed herein.

FIG. 3 shows example voltage waveforms of a program-and-verify operation that supports programming verification in a memory system in accordance with examples as disclosed herein.

FIG. 4 shows an example of a process flow that supports programming verification in a memory system in accordance with examples as disclosed herein.

FIG. 5 shows a block diagram of a memory system that supports programming verification in a memory system in accordance with examples as disclosed herein.

FIG. 6 shows a flowchart illustrating a method or methods that support programming verification in a memory system in accordance with examples as disclosed herein.

### DETAILED DESCRIPTION

A memory system may use an iterative program-and-verify technique to enable storage of multi-bit values per memory cell, where the multi-bit value are distinguished by different threshold voltages of the memory cell. To write the memory cells of a word line as multi-bit cells, the memory system may iteratively perform a programming operation and a verification operation on the word line in successive loops until the memory system has verified that word line has been successfully written with multi-bit values. For example, after applying pulses to the word line for the programming operation, the memory system may apply a verification pulse that ramps up from a first level to a second level for the verification operation. But ramping the word line voltage from the first level to the second level during the verification operation may be time-consuming and increase the overall programming time for the word line (e.g., the time it takes to program and verify the word line). Techniques for reducing the overall programming time for a word line may be desired.

According to the techniques described herein, the programming time for a word line may be reduced by using a verification pulse that ramps down from a first level to a second level. The verification pulse may ramp down (e.g., in a step-wise manner) so that different threshold voltage distributions for the word line can be verified. Ramping down the voltage used for the verification pulse may be faster than ramping up the voltage, and thus may reduce programming time of the word line by reducing the duration of the verification operation(s), among other benefits.

In addition to applicability in memory systems as described herein, techniques for reverse verification pulses may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may decrease processing or latency times, improve response times, or otherwise improve user experience, among other benefits.

In addition to applicability in memory systems as described herein, techniques for reverse verification pulses may be generally implemented to support cloud computing and storage applications. As the use of cloud computing to provide processing, storage, and networking services to multiple devices increases, many devices and systems may benefit from improved remote processing and storage capabilities. For example, increasing memory capacity or other capabilities may result in larger and more accessible storage options for users, and increasing memory access times may result in faster processing for computing or database applications. Implementing the techniques described herein may support cloud computing and storages techniques by increasing access speeds at cloud servers, resulting in increased response times and decreased processing times, among other benefits.

In addition to applicability in memory systems as described herein, techniques for reverse verification pulses may be generally implemented to support edge computing applications. Edge computing is a distributed computing paradigm that brings computation and data storage closer to the sources of data than traditional cloud services. As the use of edge computing to provide computing, storage, and networking services at locations that are geographically closer to end users increases, many devices and systems may benefit from improved processing, performance, and storage at edge devices. For example, increasing memory density, capacity, and processing power of edge devices may decrease a reliance on the devices to remote computing or devices, which may otherwise increase latency of operations performed at the devices. Implementing the techniques described herein may support edge computing techniques improving memory access speeds at edge computing devices and improving response times associated with edge computing devices), among other benefits.

Features of the disclosure are illustrated and described in the context of systems, devices, and circuits. Features of the disclosure are further illustrated and described in the context of threshold voltage distributions, program-and-verify operations, process flows, device diagrams, and flowcharts.

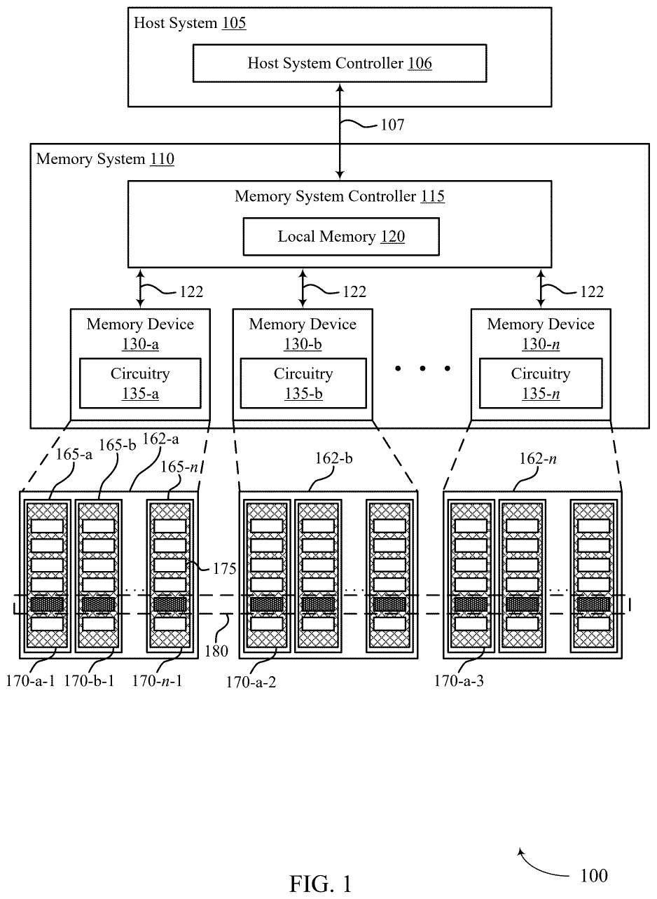

FIG. 1 shows an example of a system 100 that supports programming verification in a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface 107 with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via an interface 107. The host system 105 and the memory system 110 may, in some cases, be configured to communicate via the interface 107 using an associated protocol (e.g., to exchange or otherwise communicate control, address, data, and other signals between the memory system 110 and the host system 105). Examples of the interface 107 may include, but are not limited to, a SATA interface, a UFS interface, an eMMC interface, a PCIe interface, a USB interface, a Fiber Channel interface, a SCSI, a Serial Attached SCSI (SAS) interface, a Double Data Rate (DDR) interface, a DIMM interface (e.g., DIMM socket interface that supports DDR), an Open NAND Flash Interface (ONFI), Mobile Industry Processor Interface (MIPI) Unified Protocol (UniPro), MIPI Physical (M-PHY) interface, and a Low Power Double Data Rate (LPDDR) interface. In some examples, multiple such interfaces 107 may be included in or otherwise supported between a host system controller 106 of the host system 105 and a memory system controller 115 of the memory system 110 (e.g., the interface 107 may support communication via multiple protocol layers such as UFS at an application layer, UniPro at a transport layer, and M-PHY at a physical layer).

The memory system 110 may include a memory system controller 115 and one or more memory devices 130. A memory device 130 may include one or more memory arrays of any type of memory cells (e.g., non-volatile memory cells, volatile memory cells, or any combination thereof). The memory system 110 may include memory devices 130-a, 130-b, up to 130-n, where n represents any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the interface 107) and may be an example of a controller or control component configured to cause the memory system 110 to perform various operations in accordance with examples as described herein. The memory system controller 115 may also be coupled with and communicate with memory devices 130 via respective interfaces 122 to perform operations such as reading data, writing data, erasing data, or refreshing data at a memory device 130—among other such operations—which may generically be referred to as access operations. In some examples, the respective interfaces 122 may be examples of single data rate (SDR) interfaces, DRR interfaces, ONFI interfaces, and the like. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include volatile memory (e.g., static random access memory (SRAM), dynamic random access memory (DRAM), or other memory) that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or respective circuitry 135, which may be internal to memory devices 130, respectively, to perform the functions ascribed herein to the memory system controller 115. In general, one or more functions ascribed herein to the memory system controller 115 may, in some cases, be performed instead by the host system 105, circuitry 135, or any combination thereof. For example, the circuitry 135 may be or include a microcontroller, special purpose logic circuitry (e.g., an FPGA, an ASIC, a DSP), or any other suitable processor or processing circuitry. Thus, in some instances, “processor” or “processing circuitry” may refer to functions performed by the memory system controller 115, the host system 105, the circuitry 135 of one or more memory devices 130, or any combination thereof. In some cases, a memory system 110 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as DRAM memory cells or SRAM memory cells.

In some examples, a memory device 130 may include (e.g., on the same die, within the same package) circuitry 135, which may execute or otherwise support operations on one or more memory cells of the respective memory device 130. Respective circuitry 135 may operate in conjunction with a memory system controller 115 or may perform one or more functions ascribed herein to the memory system controller 115. For example, as illustrated in FIG. 1, a memory device 130-a may include circuitry 135-a, a memory device 130-b may include circuitry 135-b, and a memory device 130-n may include circuitry 135-n.

In some cases, a memory device 130 may be or include a NAND device (e.g., NAND flash device). A memory device 130 may be or include a die 162 (e.g., a memory die). For example, in some cases, a memory device 130 may be a package that includes one or more dies 162. A die 162 may, in some examples, be a piece of electronics-grade semiconductor cut from a wafer (e.g., a silicon die cut from a silicon wafer). The memory cells for each die 162 may be arranged in one or more planes 165, and each plane 165 may include one or more blocks 170, where each block 170 may include one or more pages 175, and each page 175 may include a set of memory cells. In some examples, each die 162 may include n planes 165 and each plane may include m blocks 170, where n and m represent positive integers.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, concurrent operations may be performed on different planes 165 or on different blocks 170. For example, concurrent operations may be performed on memory cells within different blocks 170 so long as the different blocks 170 are in different planes 165. In some examples, each memory die 162 may include any quantity of planes 165. For example, the memory die 162-a may include a plane 165-a, a plane 165-b, and a plane 165-n, where n represents an Nth plane. The memory die 162-b and the memory die 162-n may also include N planes. In some cases, an individual block 170 may be referred to as a physical block, and a virtual block 180 may refer to a group of physical blocks 170 within which concurrent operations may occur. A virtual block 180 may be a logical structure that includes a plurality of blocks, where different blocks of the plurality of blocks may come from different planes 165 or different memory dies 162. In some cases, a virtual block may include blocks 170 from different memory devices 130 (e.g., including blocks in one or more planes 165 of memory device 130-a, memory device 130-b, and memory device 130-n). In some examples, a virtual block may include a respective block from each plane 165 (e.g., a block 170 from each plane 165) of one or more memory dies 162.

In some cases, the blocks 170 within a virtual block may have the same block address within their respective planes 165. For example, block 170-a-1 may be “block 0 ” of a first plane of die 162-a, block 170-a-2 may be “block 0 ” of a first plane of die 162-b, block 170-a-3 may be “block 0 ” of a first plane of die 162-n, and so on. By way of further example, block 170-b-1 may be “block 1” of a first plane of die 162-a and block 170-n-1 may be “block n” of die 162-a, where n represents an Nth block. The memory die 162-b and the memory die 162-n may also include N blocks. In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). For example, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be restricted from being re-written with new data until they are erased. Thus, for example, an invalid page 175 may, in some cases, not be updated until the entire block 170 that includes the page 175 has been erased.

The memory system 110 may support an iterative program-and-verify technique that allows the memory system 110 to store multi-bit values in the memory cells of the memory devices 130. If the memory system 110 is operating the memory cells as multi-level cells (MLCs), each memory cell may store two bits of information using four different threshold voltage (Vt) levels, where each Vt level corresponds to a unique two-bit value. If the memory system 110 is operating the memory cells as triple-level cells (TLCs), each memory cell may store three bits of information using eight different Vt levels, where each Vt level corresponds to a unique three-bit value. If the memory system 110 is operating the memory cells as quad-level cells (QLCs), each memory cell may store four bits of information using sixteen different Vt levels, where each Vt level corresponds to a unique four-bit value. Memory cells that store more than one bit may be referred to as multi-bit memory cells.

Programming a word line of memory cells (sometimes referred to as programming a word line) as multi-bit memory cells may involve the application of various pulses (e.g., voltage pulses) to the word line coupled with the memory cells. For example, the memory cells of the word line may be programmed by performing a multi-pulse programming operation followed by a verification pulse of an verification operation. The multi-pulse programming operation may change the threshold voltage levels of the memory cells whereas the verification pulse of the verification operation may allow the memory system 110 to sense the threshold voltage levels of the memory cells so that the memory system 110 can determine whether the word line has been successfully programmed. A word line may be referred to as being successfully programmed if, for each threshold voltage level corresponding to a unique multi-bit value, the distribution of threshold voltages associated with that word line satisfies a target distribution. Programming a memory cell or word line may also be referred to as writing the memory cell or word line.

In some memory systems, the verification pulse applied to a word line may be a forward verification pulse that increases from a first voltage level to a second voltage level. But such a verification pulse may take a long time to reach the second voltage level. According to the techniques described herein, the duration of a verification operation, and thus the duration of the programming time for a word line, may be reduced by using a reverse verification pulse that decreases from a first voltage level to a second voltage level. Decreasing the voltage of the verification pulse may be faster than increasing the voltage, and thus may enable a shorter verification pulse relative to the forward verification pulse.

The system 100 may include any quantity of non-transitory computer readable media that support programming verification in a memory system. For example, the host system 105 (e.g., a host system controller 106), the memory system 110 (e.g., a memory system controller 115), or a memory device 130 (e.g., a circuitry 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by circuitry 135), may cause the host system 105, the memory system 110, or the memory device 130 to perform associated functions as described herein.

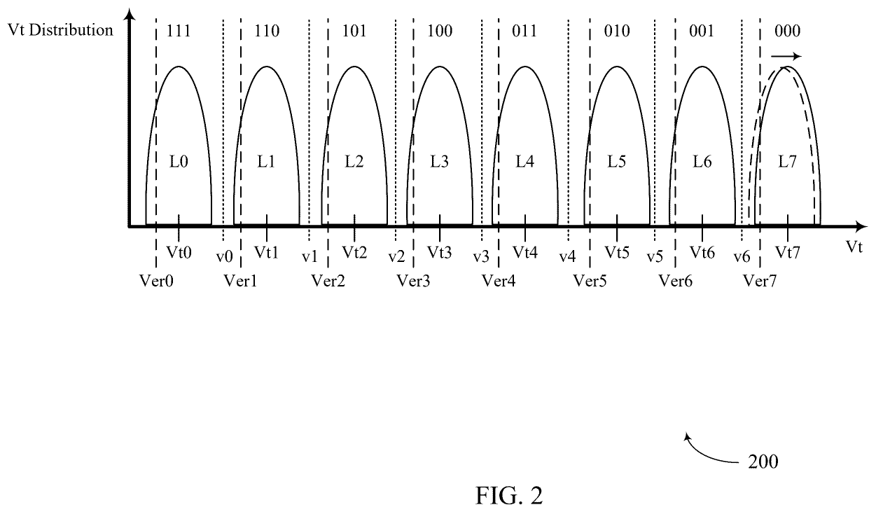

FIG. 2 shows an example of threshold voltage distributions 200 that support programming verification in a memory system in accordance with examples as disclosed herein. The threshold voltage distributions 200 may be for one or more word lines of TLC cells and thus may include eight threshold distributions labeled L0 through L7. The threshold voltage distributions may be centered around eight target threshold voltage levels denoted Vt0 through Vt7, each of which may correspond to a unique three-bit value. For example, the target Vt level Vt0 may correspond to the three-bit value of ‘111,” whereas the target Vt level Vt1 may correspond to the three-bit value of ‘110.” During a normal (e.g., non-verification) sensing operation, a cell may be considered as being in the L0 distribution if the sensed threshold voltage of the memory cell is below voltage v0, whereas a cell may be counted as being in the L1 distribution if the sensed threshold voltage of the memory cell is above voltage v0 and below voltage 1. And so on and so forth.

During a verification operation, the threshold voltages of the memory cells of a word line may be sensed using a reverse verification pulse as described herein. After the verification pulse (e.g., during a subsequent programming operation of the next program-and-verify loop), the memory cells in each distribution may be determined using a counting procedure that may be referred to as a CFBit procedure. In the CFBit procedure, a memory cell may be counted as a being in the L0 distribution if the sensed threshold voltage of the memory cell is between voltage Ver0 and voltage v0, whereas a memory cell may be counted as being in the L1 distribution if the sensed threshold voltage of the memory cell is between voltage Ver1 and voltage v1. And so on and so forth.

Counting the memory cells in each Vt distribution may allow the memory system to determine whether the word line has been successfully programmed. For example, the memory system may compare the quantity of memory cells in each Vt distribution to a threshold quantity (e.g., x). If the quantity of memory cells in a Vt distribution satisfies the threshold quantity (e.g., if the quantity is greater than or equal to x), the memory system may determine that the word line was successfully programmed. However, if the quantity of memory cells in a Vt distribution does not satisfy the threshold quantity (e.g., if the quantity is less than x), the memory system may determine that the word line was not successfully programmed. Accordingly, the memory system may perform another program-and-verify loop on the word line. During the program-and-verify loop, the programming pulse of the programming operation may be increased relative to the previous program-and-verify loop so that one or more of the Vt distribution(s) of the word line are shifted rightward (e.g., to greater Vt levels). For example, as illustrated in FIG. 2, the L7 distribution may shift rightward so that a greater quantity of memory cells have Vt levels that are greater than the voltage Ver7.

According to the techniques described herein, the duration of a verification operation, and thus the duration of a program-and-verify loop, may be decreased by using a reverse verification pulse.

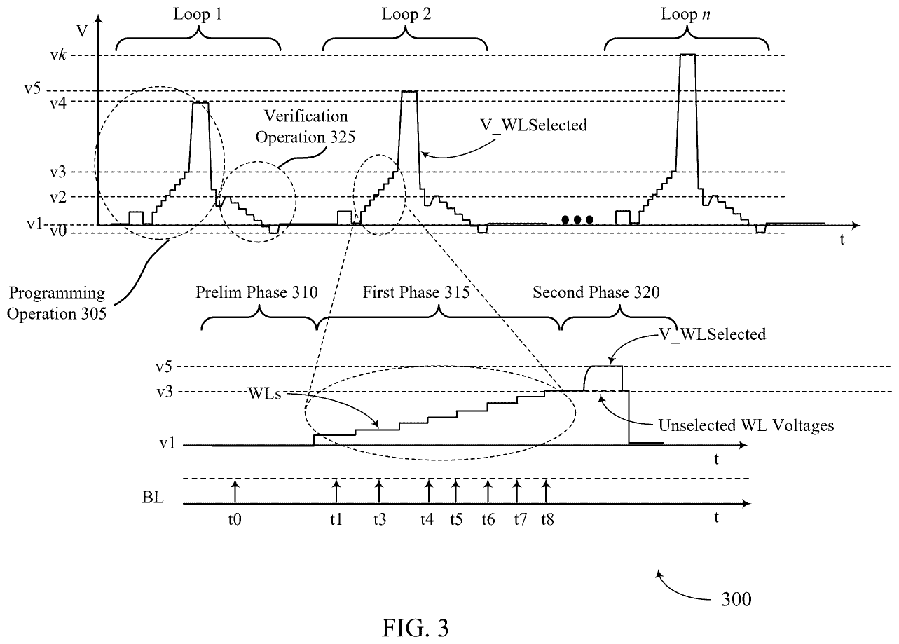

FIG. 3 shows example voltage waveforms of a program-and-verify operation 300 that supports programming verification in a memory system in accordance with examples as disclosed herein. The program-and-verify operation 300 may be performed by a memory device such as a memory device 130 described with reference to FIG. 1. The program-and-verify operation 300 may be used to program the memory cells of a word line with a target set of multi-bit values and to verify that the target set of multi-bit values was successfully written to the memory cells. In FIG. 3, the voltage of the word line selected for the program-and-verify-operation 300 is denoted V_WLSelected.

The program-and-verify operation 300 may include multiple (e.g., n) program-and-verify loops, where each program-and-verify loop may include a programming operation 305 and a verification operation 325. A programming operation 305 may attempt to write a target set of multi-bit values to the memory cells of a word line, and a verification operation 325 may be used to verify whether the target set of multi-bit values has been successfully written. That is, the verification operation 325 may be used to verify whether a sensed set of multi-bit values from the memory cells (after the programming operation 305) is the target set of multi-bit values or a different set of multi-bit values. If the sensed set of multi-bit values from the memory cells is not the target set of multi-bit values, the memory device may perform another program-and-verify loop. To decrease the latency of the program-and-verify loops, and thus the overall programming time, the verification operations 325 may use a reverse verification pulse that ramps in a step-wise manner from a higher voltage level (e.g., v2) to a lower voltage level (e.g., v0). A programming operation 305 may also be referred to as an all-level programming (ALP) operation.

A programming operation 305 may have multiple phases. For example, a programming operation 305 may include a preliminary phase 310, a first phase 315, and a second phase 320. During the preliminary phase 310, the memory cells of the word line selected for programming (referred to as the selected word line) may be prepared for programming by driving the selected word line to a voltage level v1 and by driving the digit lines coupled with the memory cells to an initial voltage level. In some examples, the preliminary phase 310 may be referred to as a first preparation phase for the programming operation 305.

During the first phase 315, the memory cells of the selected word line may be placed into various states that support the programming of the target set of multi-bit values intended to be written to the memory cells. To do so, the voltage of the selected word line may be increased in a step-wise manner from the voltage level v1 to the voltage level v3, where different levels between voltage level v1 and voltage level v3 may be associated with different target threshold levels. Increasing a voltage in a step-wise (or “staircase”) manner may refer to the technique of maintaining the voltage at discrete levels for a duration of time in between increasing the voltage to the different discrete levels.

During the first phase 315, the digit lines of the memory cells of the selected word line may be increased at different times (e.g., time t0, time t1, time t2, etc.) depending on the multi-bit values to be written to the memory cells. For example, the voltage of the digit lines of a first subset of memory cells may be increased at time t1 to write a first multi-bit value to the first subset of memory cells, and the voltage of the digit lines of a second subset of memory cells may be increased at time t3 to write a second multi-bit value to the second subset of memory cells. In some examples, the first phase 315 may be referred to as a second preparation phase for the programming operation 305.

During the second phase 320, the memory cells of the selected word line may be written based on the target set of multi-bit values. To do so, the voltage of the selected word line may be increased from the voltage level v3 to a higher (e.g., peak) voltage level. The peak voltage level may be progressively higher each subsequent program-and-verify loop so that the Vt distributions associated with the selected word line are shifted rightward as illustrated in FIG. 2. For example, the peak voltage level may be voltage level v4 for program-and-verify loop 1, may be voltage level v5 for program-and-verify loop 2, and may be voltage level vk for program-and-verify loop n. The word line voltage may be maintained at the peak voltage level for a duration that enables programming of the memory cells before being decreased to an intermediate voltage level between the voltage level v3 and the voltage level v2.

In some cases, in addition to the selected word line, a set of unselected word lines may undergo the preliminary phase 310 and the first phase 315. In such cases, the voltages of the unselected set of word lines may be maintained at the voltage level v3 during the second phase 320. In some examples, the second phase 320 may be referred to as a programming phase of the programming operation 305.

After the second phase 320, the memory cells coupled with the selected word line may or may not be written with the target set of multi-bit values. For example, the memory cells may be written to a different set of multi-bit values than the target set of multi-bit values. To verify whether the memory cells coupled with the selected word line are written with the target set of multi-bit values, the memory system may perform the verification operation 325.

During the verification operation 325, the memory system may sense the threshold voltages of the memory cells to determine the multi-bit values stored by the memory cells. To do so, the memory system may apply a reverse verification pulse to the word line. For example, the memory system may decrease, in a step-wise manner, the voltage applied to the selected word line from the voltage level v2 to the voltage level v0. Decreasing the voltage applied to the selected word line may be faster than increasing the voltage applied to the selected word line, and thus may decrease the duration of the verification operation 325 relative to techniques that use a forward verification pulse. Thus, the voltage applied to the selected word line may be increased (e.g., from voltage level v1 to voltage level v3) in a step-wise manner during the first phase 315 of the programming operation 305 and may be decreased (e.g., from voltage level v2 to voltage level v0) in a step-wise manner during the verification operation 325.

A verification operation 325 may allow the memory system to verify whether the memory cells are programmed to the target set of multi-bit values. For example, during the next program-and-verify loop (e.g., the program-and-verify loop after the verification operation 325), the memory system may count the quantity of memory cells in each Vt distribution based on the threshold voltages of the memory cells sensed during the verification operation 325. As an illustration, if the verification operation 325 is performed in program-and-verify loop i (e.g., loop 1), the memory system may count the quantity of memory cells in the Vt distributions during the programming operation 305 of the program-and-verify loop i+1 (e.g., loop 2). If the memory cells are being operated as TLCs, the memory system may determine the quantity of memory cells in each Vt distribution L0 through L7 as described with reference to FIG. 2. If the memory cells are being operated as MLCs, the memory system may determine the quantity of memory cells in each of the four Vt distributions. If the memory cells are being operated as QLCs, the memory system may determine the quantity of memory cells in each of the sixteen Vt distributions.

If, for any Vt distribution, the quantity of memory cells is less than a threshold associated with that Vt distribution, the memory system may determine that the memory cells were not successfully programmed with the target set of multi-bit values. Accordingly, the memory system may perform another program-and-verify loop (e.g., with a higher peak voltage for the second phase 320). However, if, for each Vt distribution, the quantity of memory cells is greater than or equal to the associated threshold, the memory system may determine that the memory cells were successfully programmed with the target set of multi-bit values. Accordingly, the memory system may refrain from performing another program-and-verify loop.

Thus, the memory system may perform a program-and-verify operation that includes a reverse verification pulse, which may reduce the duration of the program-and-verify operation, and thus the overall programming time relative to other techniques. The techniques described herein may be implemented for any programming order, including drain-to-source (D2S) and source-to-drain (S2D). Further, the techniques described herein may be implemented for any type of non-volatile memory, including resistive random access memory (ReRAM) and phase change memory (PCM). Additionally, the techniques described herein may be implemented for any type of system block, including normal blocks, partial blocks, or blocks by deck.

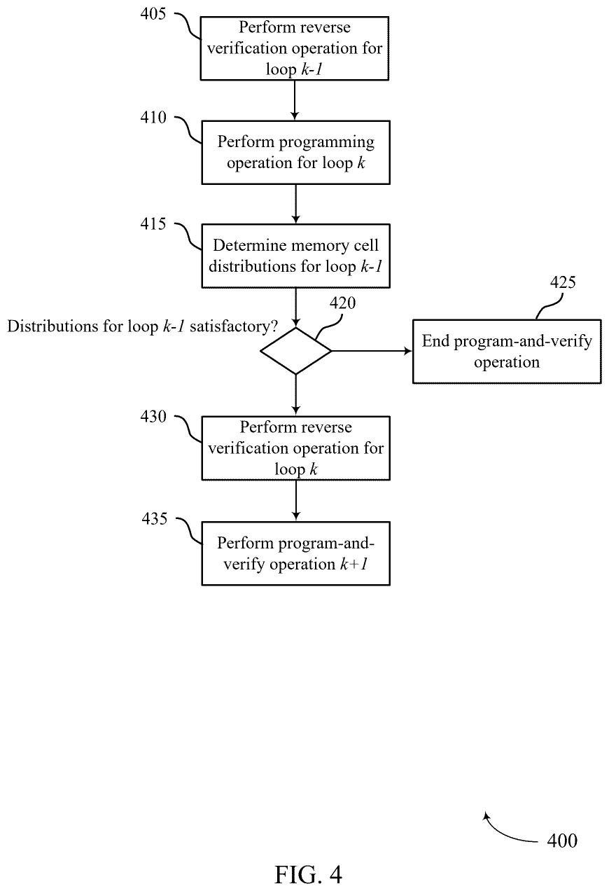

FIG. 4 shows an example of a process flow 400 that supports programming verification in a memory system in accordance with examples as disclosed herein. The process flow 400 may be implemented by a memory system as described herein. As part of the process flow 400, the memory system may perform verification operations with reverse verification pulses, which may reduce the programming time of the memory system.

At 405, the memory system may perform a verification operation (for program-and-verify loop k−1) for a set of memory cells coupled with a word line. The verification operation may be an example of the verification operations 325 described with reference to FIG. 3. Accordingly, the verification operation may include decreasing, in a step-wise manner, the voltage applied to the word line. During the verification operation, the multi-bit values stored by the set of memory cells may be determined (e.g., by sensing the threshold voltages of the set of memory cells). If the verification operation is for MLCs, the set of multi-bit values sensed during the verification operation may include each MLC multi-bit value. If the verification operation is for TLCs, the set of multi-bit values sensed during the verification operation may include each TLC multi-bit value. If the verification operation is for QLCs, the set of multi-bit values sensed during the verification operation may include each QLC multi-bit value.

At 410, the memory system may perform a programming operation (for program-and-verify loop k) for the set of memory cells coupled with the word line. The programming operation may be an example of the programming operations 305 described with reference to FIG. 3. Accordingly, the programming operation may attempt to write a set of multi-bit values to the set of memory cells. If the programming operation is for MLCs, the set of multi-bit values attempted to be written may include each MLC multi-bit value. If the programming operation is for TLCs, the set of multi-bit values attempted to be written may include each TLC multi-bit value. If the programming operation is for QLCs, the set of multi-bit values attempted to be written may include each QLC multi-bit value.

At 415, the memory system may determine (for program-and-verify loop k−1) the distributions of the set of memory cells. For example, the memory system may determine the Vt distributions based on the sensed threshold voltages of the set of memory cells. For each multi-bit value, the memory system may determine the quantity of memory cells with threshold voltages within the range of threshold voltages associated with that multi-bit value. The memory system may determine the distribution for program-and-verify loop k−1 concurrently with performing the programming operation for program-and-verify loop k.

At 420, the memory system may determine whether the distributions for program-and-verify loop k−1 is satisfactory. The distributions may be considered satisfactory if, for each multi-bit value, the quantity of memory cells with threshold voltages within the range of threshold voltages associated with that multi-bit value is greater than or equal to a threshold quantity. If the memory system determines that the distributions for program-and-verify loop k−1 is satisfactory, the memory system may determine that the set of multi-bit values has been successfully written to the set of memory cells. Accordingly, the memory system may proceed to 425 and end the program-and-verify operation for that word line.

If the memory system determines that the distributions for program-and-verify loop k−1 is not satisfactory, the memory system may determine that the set of multi-bit values has not been successfully written to the set of memory cells. Accordingly, the memory system may proceed to 430 and perform a verification operation on the set of memory cells for program-and-verify loop k (so that the memory system can determine the distribution for program-and-verify loop k during the programming operation for program-and-verify loop k+1). The verification operation may include decreasing, in a step-wise manner, the voltage applied to the word line. The memory system may then, at 435, perform the programming operation for program-and-verify loop k+1. The process may repeat until the memory system determines that the set of multi-bit values has been written to the set of memory cells coupled with the word line.

Thus, the memory system may perform verification operations with reverse verification pulses, which may reduce the programming time of the memory system.

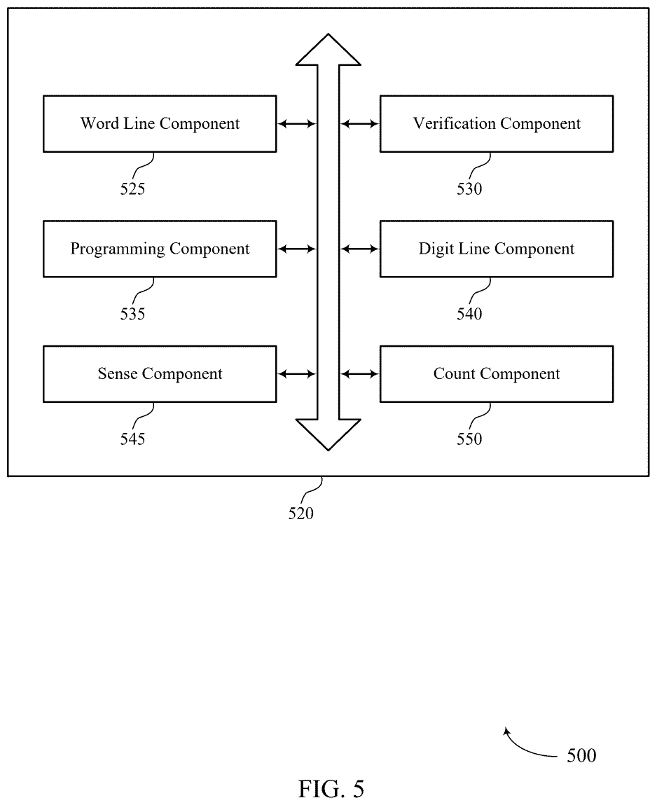

FIG. 5 shows a block diagram 500 of a memory system 520 that supports programming verification in a memory system in accordance with examples as disclosed herein. The memory system 520 may be an example of aspects of a memory system as described with reference to FIGS. 1 through 4. The memory system 520, or various components thereof, may be an example of means for performing various aspects of programming verification in a memory system as described herein. For example, the memory system 520 may include a word line component 525, a verification component 530, a programming component 535, a digit line component 540, a sense component 545, a count component 550, or any combination thereof. Each of these components, or components of subcomponents thereof (e.g., one or more processors, one or more memories), may communicate, directly or indirectly, with one another (e.g., via one or more buses).

The word line component 525 may be configured as or otherwise support a means for increasing, in a step-wise manner during a first phase of a programming operation for a word line, a voltage applied to the word line to a first level. In some examples, the word line component 525 may be configured as or otherwise support a means for increasing, during a second phase of the programming operation, the voltage applied to the word line from the first level to a second level higher than the first level, where a set of memory cells coupled with the word line is attempted to be written with a set of multi-bit values based at least in part on increasing the voltage to the second level. In some examples, the word line component 525 may be configured as or otherwise support a means for decreasing, in a step-wise manner during a verification operation for the programming operation, the voltage applied to the word line to a third level lower than the first level; and. The verification component 530 may be configured as or otherwise support a means for determining whether the set of memory cells has been written with the set of multi-bit values based at least in part on decreasing the voltage applied to the word line.

In some examples, the programming component 535 may be configured as or otherwise support a means for performing a second programming operation for the word line based at least in part on determining that the set of memory cells has not been written with the set of multi-bit values.

In some examples, to support performing the second programming operation, the word line component 525 may be configured as or otherwise support a means for increasing, in a step-wise manner during a first phase of the second programming operation, the voltage applied to the word line to the first level. In some examples, to support performing the second programming operation, the word line component 525 may be configured as or otherwise support a means for increasing, during a second phase of the second programming operation, the voltage applied to the word line from the first level to a fourth level higher than the second level.

In some examples, the word line component 525 may be configured as or otherwise support a means for decreasing, during the second phase of the programming operation, the voltage applied to the word line from the second level to a fourth level between the first level and the third level.

In some examples, the digit line component 540 may be configured as or otherwise support a means for increasing, at a first time during the first phase of the programming operation, a voltage applied to a first subset of digit lines coupled with a first subset of the set of memory cells, where each memory cell in the first subset is written with a first multi-bit value based at least in part on increasing the voltage applied to the first subset of digit lines.

In some examples, the digit line component 540 may be configured as or otherwise support a means for increasing, at a second time during the first phase of the programming operation, a voltage applied to a second subset of digit lines coupled with a second subset of the set of memory cells, where each memory cell in the second subset is written with a second multi-bit value based at least in part on increasing the voltage applied to the second subset of digit lines.

In some examples, the sense component 545 may be configured as or otherwise support a means for sensing a set of threshold voltages from the set of memory cells based at least in part on decreasing the voltage applied to the word line. In some examples, the count component 550 may be configured as or otherwise support a means for determining, based at least in part on sensing the set of threshold voltages, a quantity of the set of memory cells with associated threshold voltages within a range of threshold voltages associated with a multi-bit value of the set of multi-bit values, where the set of memory cells is determined to have been written with the set of multi-bit values based at least in part on the quantity.

In some examples, the count component 550 may be configured as or otherwise support a means for determining that the quantity of the set of memory cells with associated threshold voltages within the range of threshold voltages associated with the multi-bit value satisfies a threshold, where the set of memory cells is determined to have been written with the set of multi-bit values based at least in part on the quantity satisfying the threshold.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

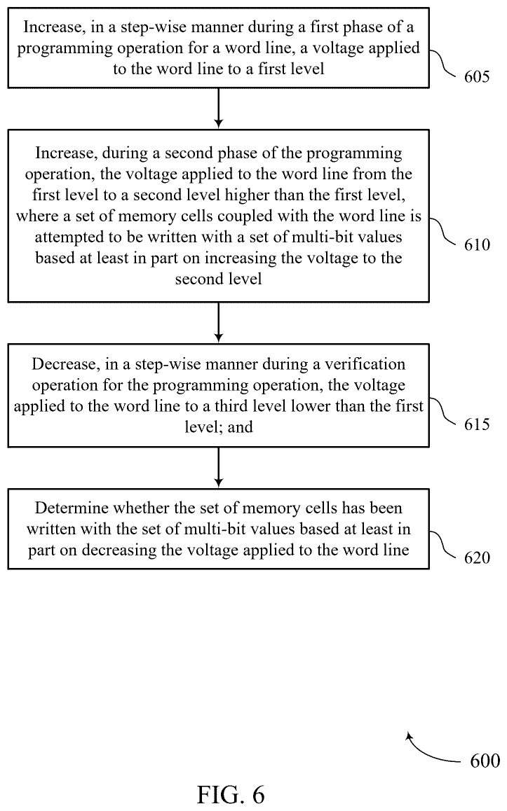

FIG. 6 shows a flowchart illustrating a method 600 that supports programming verification in a memory system in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include increasing, in a step-wise manner during a first phase of a programming operation for a word line, a voltage applied to the word line to a first level. In some examples, aspects of the operations of 605 may be performed by a word line component 525 as described with reference to FIG. 5.

At 610, the method may include increasing, during a second phase of the programming operation, the voltage applied to the word line from the first level to a second level higher than the first level, where a set of memory cells coupled with the word line is attempted to be written with a set of multi-bit values based at least in part on increasing the voltage to the second level. In some examples, aspects of the operations of 610 may be performed by a word line component 525 as described with reference to FIG. 5.

At 615, the method may include decreasing, in a step-wise manner during a verification operation for the programming operation, the voltage applied to the word line to a third level lower than the first level; and. In some examples, aspects of the operations of 615 may be performed by a word line component 525 as described with reference to FIG. 5.

At 620, the method may include determining whether the set of memory cells has been written with the set of multi-bit values based at least in part on decreasing the voltage applied to the word line. In some examples, aspects of the operations of 620 may be performed by a verification component 530 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for increasing, in a step-wise manner during a first phase of a programming operation for a word line, a voltage applied to the word line to a first level; increasing, during a second phase of the programming operation, the voltage applied to the word line from the first level to a second level higher than the first level, where a set of memory cells coupled with the word line is attempted to be written with a set of multi-bit values based at least in part on increasing the voltage to the second level; decreasing, in a step-wise manner during a verification operation for the programming operation, the voltage applied to the word line to a third level lower than the first level; and; and determining whether the set of memory cells has been written with the set of multi-bit values based at least in part on decreasing the voltage applied to the word line.

Aspect 2: The method, apparatus, or non-transitory computer-readable medium of aspect 1, further including operations, features, circuitry, logic, means, or instructions, or any combination thereof for performing a second programming operation for the word line based at least in part on determining that the set of memory cells has not been written with the set of multi-bit values.

Aspect 3: The method, apparatus, or non-transitory computer-readable medium of aspect 2, where performing the second programming operation includes operations, features, circuitry, logic, means, or instructions, or any combination thereof for increasing, in a step-wise manner during a first phase of the second programming operation, the voltage applied to the word line to the first level and increasing, during a second phase of the second programming operation, the voltage applied to the word line from the first level to a fourth level higher than the second level.

Aspect 4: The method, apparatus, or non-transitory computer-readable medium of any of aspects 1 through 3, further including operations, features, circuitry, logic, means, or instructions, or any combination thereof for decreasing, during the second phase of the programming operation, the voltage applied to the word line from the second level to a fourth level between the first level and the third level.

Aspect 5: The method, apparatus, or non-transitory computer-readable medium of any of aspects 1 through 4, further including operations, features, circuitry, logic, means, or instructions, or any combination thereof for increasing, at a first time during the first phase of the programming operation, a voltage applied to a first subset of digit lines coupled with a first subset of the set of memory cells, where each memory cell in the first subset is written with a first multi-bit value based at least in part on increasing the voltage applied to the first subset of digit lines.

Aspect 6: The method, apparatus, or non-transitory computer-readable medium of aspect 5, further including operations, features, circuitry, logic, means, or instructions, or any combination thereof for increasing, at a second time during the first phase of the programming operation, a voltage applied to a second subset of digit lines coupled with a second subset of the set of memory cells, where each memory cell in the second subset is written with a second multi-bit value based at least in part on increasing the voltage applied to the second subset of digit lines.

Aspect 7: The method, apparatus, or non-transitory computer-readable medium of any of aspects 1 through 6, further including operations, features, circuitry, logic, means, or instructions, or any combination thereof for sensing a set of threshold voltages from the set of memory cells based at least in part on decreasing the voltage applied to the word line and determining, based at least in part on sensing the set of threshold voltages, a quantity of the set of memory cells with associated threshold voltages within a range of threshold voltages associated with a multi-bit value of the set of multi-bit values, where the set of memory cells is determined to have been written with the set of multi-bit values based at least in part on the quantity.

Aspect 8: The method, apparatus, or non-transitory computer-readable medium of aspect 7, further including operations, features, circuitry, logic, means, or instructions, or any combination thereof for determining that the quantity of the set of memory cells with associated threshold voltages within the range of threshold voltages associated with the multi-bit value satisfies a threshold, where the set of memory cells is determined to have been written with the set of multi-bit values based at least in part on the quantity satisfying the threshold.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
processing circuitry associated with one or more memory devices and configured to cause the apparatus to:
increase, in a step-wise manner during a first phase of a programming operation for a word line, a voltage applied to the word line to a first level;
increase, during a second phase of the programming operation, the voltage applied to the word line from the first level to a second level higher than the first level, wherein a set of memory cells coupled with the word line is attempted to be written with a set of multi-bit values based at least in part on increasing the voltage to the second level;
decrease, in a step-wise manner during a verification operation for the programming operation, the voltage applied to the word line to a third level lower than the first level; and
determine whether the set of memory cells has been written with the set of multi-bit values based at least in part on decreasing the voltage applied to the word line.

2. The apparatus of claim 1, wherein the processing circuitry is further configured to cause the apparatus to:
perform a second programming operation for the word line based at least in part on determining that the set of memory cells has not been written with the set of multi-bit values.

3. The apparatus of claim 2, wherein performing the second programming operation comprises the processing circuitry configured to cause the apparatus to:
increase, in a step-wise manner during a first phase of the second programming operation, the voltage applied to the word line to the first level; and
increase, during a second phase of the second programming operation, the voltage applied to the word line from the first level to a fourth level higher than the second level.

4. The apparatus of claim 1, wherein the processing circuitry is further configured to cause the apparatus to:
decrease, during the second phase of the programming operation, the voltage applied to the word line from the second level to a fourth level between the first level and the third level.

5. The apparatus of claim 1, wherein the processing circuitry is further configured to cause the apparatus to:
increase, at a first time during the first phase of the programming operation, a voltage applied to a first subset of digit lines coupled with a first subset of the set of memory cells, wherein each memory cell in the first subset is written with a first multi-bit value based at least in part on increasing the voltage applied to the first subset of digit lines.

6. The apparatus of claim 5, wherein the processing circuitry is further configured to cause the apparatus to:
increase, at a second time during the first phase of the programming operation, a voltage applied to a second subset of digit lines coupled with a second subset of the set of memory cells, wherein each memory cell in the second subset is written with a second multi-bit value based at least in part on increasing the voltage applied to the second subset of digit lines.

7. The apparatus of claim 1, wherein the processing circuitry is further configured to cause the apparatus to:
sense a set of threshold voltages from the set of memory cells based at least in part on decreasing the voltage applied to the word line; and
determine, based at least in part on sensing the set of threshold voltages, a quantity of the set of memory cells with associated threshold voltages within a range of threshold voltages associated with a multi-bit value of the set of multi-bit values, wherein the set of memory cells is determined to have been written with the set of multi-bit values based at least in part on the quantity.

8. The apparatus of claim 7, wherein the processing circuitry is further configured to cause the apparatus to:
determine that the quantity of the set of memory cells with associated threshold voltages within the range of threshold voltages associated with the multi-bit value satisfies a threshold, wherein the set of memory cells is determined to have been written with the set of multi-bit values based at least in part on the quantity satisfying the threshold.

9. A method, comprising:
increasing, in a step-wise manner during a first phase of a programming operation for a word line, a voltage applied to the word line to a first level;
increasing, during a second phase of the programming operation, the voltage applied to the word line from the first level to a second level higher than the first level, wherein a set of memory cells coupled with the word line is attempted to be written with a set of multi-bit values based at least in part on increasing the voltage to the second level;
decreasing, in a step-wise manner during a verification operation for the programming operation, the voltage applied to the word line to a third level lower than the first level; and
determining whether the set of memory cells has been written with the set of multi-bit values based at least in part on decreasing the voltage applied to the word line.

10. The method of claim 9, further comprising:
performing a second programming operation for the word line based at least in part on determining that the set of memory cells has not been written with the set of multi-bit values.

11. The method of claim 10, wherein performing the second programming operation comprises:
increasing, in a step-wise manner during a first phase of the second programming operation, the voltage applied to the word line to the first level; and
increasing, during a second phase of the second programming operation, the voltage applied to the word line from the first level to a fourth level higher than the second level.

12. The method of claim 9, further comprising:
decreasing, during the second phase of the programming operation, the voltage applied to the word line from the second level to a fourth level between the first level and the third level.

13. The method of claim 9, further comprising:
increasing, at a first time during the first phase of the programming operation, a voltage applied to a first subset of digit lines coupled with a first subset of the set of memory cells, wherein each memory cell in the first subset is written with a first multi-bit value based at least in part on increasing the voltage applied to the first subset of digit lines.

14. The method of claim 13, further comprising:
increasing, at a second time during the first phase of the programming operation, a voltage applied to a second subset of digit lines coupled with a second subset of the set of memory cells, wherein each memory cell in the second subset is written with a second multi-bit value based at least in part on increasing the voltage applied to the second subset of digit lines.

15. The method of claim 9, further comprising:
sensing a set of threshold voltages from the set of memory cells based at least in part on decreasing the voltage applied to the word line; and
determining, based at least in part on sensing the set of threshold voltages, a quantity of the set of memory cells with associated threshold voltages within a range of threshold voltages associated with a multi-bit value of the set of multi-bit values, wherein the set of memory cells is determined to have been written with the set of multi-bit values based at least in part on the quantity.

16. The method of claim 15, further comprising:
determining that the quantity of the set of memory cells with associated threshold voltages within the range of threshold voltages associated with the multi-bit value satisfies a threshold, wherein the set of memory cells is determined to have been written with the set of multi-bit values based at least in part on the quantity satisfying the threshold.

17. A non-transitory computer-readable medium storing code, the code comprising instructions executable by one or more processors to:
increase, in a step-wise manner during a first phase of a programming operation for a word line, a voltage applied to the word line to a first level;
increase, during a second phase of the programming operation, the voltage applied to the word line from the first level to a second level higher than the first level, wherein a set of memory cells coupled with the word line is attempted to be written with a set of multi-bit values based at least in part on increasing the voltage to the second level;
decrease, in a step-wise manner during a verification operation for the programming operation, the voltage applied to the word line to a third level lower than the first level; and
determine whether the set of memory cells has been written with the set of multi-bit values based at least in part on decreasing the voltage applied to the word line.

18. The non-transitory computer-readable medium of claim 17, wherein the instructions are further executable by the one or more processors to:
perform a second programming operation for the word line based at least in part on determining that the set of memory cells has not been written with the set of multi-bit values.

19. The non-transitory computer-readable medium of claim 18, wherein the instructions to perform the second programming operation are executable by the one or more processors to:
increase, in a step-wise manner during a first phase of the second programming operation, the voltage applied to the word line to the first level; and
increase, during a second phase of the second programming operation, the voltage applied to the word line from the first level to a fourth level higher than the second level.

20. The non-transitory computer-readable medium of claim 17, wherein the instructions are further executable by the one or more processors to:
decrease, during the second phase of the programming operation, the voltage applied to the word line from the second level to a fourth level between the first level and the third level.

21. The non-transitory computer-readable medium of claim 17, wherein the instructions are further executable by the one or more processors to:
increase, at a first time during the first phase of the programming operation, a voltage applied to a first subset of digit lines coupled with a first subset of the set of memory cells, wherein each memory cell in the first subset is written with a first multi-bit value based at least in part on increasing the voltage applied to the first subset of digit lines.

22. The non-transitory computer-readable medium of claim 21, wherein the instructions are further executable by the one or more processors to:
increase, at a second time during the first phase of the programming operation, a voltage applied to a second subset of digit lines coupled with a second subset of the set of memory cells, wherein each memory cell in the second subset is written with a second multi-bit value based at least in part on increasing the voltage applied to the second subset of digit lines.

23. The non-transitory computer-readable medium of claim 17, wherein the instructions are further executable by the one or more processors to:
sense a set of threshold voltages from the set of memory cells based at least in part on decreasing the voltage applied to the word line; and
determine, based at least in part on sensing the set of threshold voltages, a quantity of the set of memory cells with associated threshold voltages within a range of threshold voltages associated with a multi-bit value of the set of multi-bit values, wherein the set of memory cells is determined to have been written with the set of multi-bit values based at least in part on the quantity.

24. The non-transitory computer-readable medium of claim 23, wherein the instructions are further executable by the one or more processors to:
determine that the quantity of the set of memory cells with associated threshold voltages within the range of threshold voltages associated with the multi-bit value satisfies a threshold, wherein the set of memory cells is determined to have been written with the set of multi-bit values based at least in part on the quantity satisfying the threshold.
